(19) United States
(12) Patent Application Publication
(10) Pub. No.: US 2010/0223133 A1
(43) Pub. Date: Sep. 2, 2010

(54) COMMUNICATIONS SYSTEM PROVIDING MOBILE WIRELESS COMMUNICATIONS DEVICE PREDICTED SEARCH QUERY TERMS BASED UPON GROUPS OF RELATED ADVERTISING TERMS

(75) Inventors: Sherryl Lee Lorraine Scott, Toronto (CA); Jason T. Griffin, Kitchener (CA); Scott Reeve, Waterloo (CA); Gerhard Dietrich Klassen, Waterloo (CA)

Correspondence Address: Allen, Dyer, Doppelt, Milbrath & Gilchrist - RIM, 255 S. Orange Avenue, Suite 1401, Orlando, FL, 32801, US

(73) Assignee: Research In Motion Limited, Waterloo (CA)

(21) Appl. No.: 12/394,091

(22) Filed: Feb. 27, 2009

(51) Int. Cl. G06Q 30/00; H04M 1/00; G06N 5/02; G06F 17/30

(52) U.S. Cl. 705/14.54; 455/550.1; 706/46

(57) ABSTRACT

A communications system may include an advertising server for providing at least one group of related advertising terms, and a mobile wireless communications device comprising a display, a user input device, and a processor coupled to the display and the user input device. The processor may be configured to display a user search interface on the display, receive entry of search query characters, and match the entered search query characters to identify at least one predicted search query term. Moreover, if the at least one predicted search query term is among the at least one group of related advertising terms, then the processor may cause the display to display at least one other of the group that would otherwise not match the entered search query character data.

### TECHNICAL FIELD

The present disclosure relates to the field of communications systems, and, more particularly, to mobile wireless communications systems and related methods.

### BACKGROUND

Mobile communications systems continue to grow in popularity and have become an integral part of both personal and business communications. Mobile telephones allow users to place and receive voice calls most anywhere they travel. Moreover, as mobile telephone technology has increased, so too has the functionality of mobile devices and the different types of devices available to users. For example, many mobile devices now incorporate personal digital assistant (PDA) features such as calendars, address books, task lists, etc. Moreover, such multi-function devices may also allow users to wirelessly send and receive electronic mail (email) messages and access the Internet via a cellular network and/or a wireless local area network (WLAN), for example.

As a result, users continue to spend more time using their mobile devices during the course of a day performing information searches, reading emails, etc., as opposed to early cellular phones that were used only for phones calls. This has resulted in a significant interest from the advertising community in targeting advertisements to mobile devices.

### BRIEF DESCRIPTION OF THE DRAWINGS

FIG. 1 is a schematic block diagram of a communications system in accordance with one exemplary embodiment providing search query term prediction based upon advertising term groups.

FIG. 2 is a front view of an exemplary embodiment of the mobile wireless communications device of the system of FIG. 1.

FIG. 3 and FIGS. 4A-4B are flow diagrams illustrating method aspects in accordance with exemplary embodiments.

FIG. 5 is a schematic block diagram illustrating exemplary components of a mobile wireless communications device that may be used in accordance with the system of FIG. 1.

### DETAILED DESCRIPTION

The present description is made with reference to the accompanying drawings, in which various embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements or steps in alternative embodiments.

Generally speaking, a communications system is disclosed herein which may include an advertising server for providing at least one group of related advertising terms, and a mobile wireless communications device comprising a display, a user input device, and a processor coupled to the display and the user input device. More particularly, the processor may be configured to display a user search interface on the display, and receive entry of search query character data, and match the entered search query characters to identify at least one predicted search query term. Moreover, if the at least one predicted search query term is among the at least one group of related advertising terms, then the processor may cause the display to display at least one other of the group that would otherwise not match the entered search query character data.

The user input device may include a key pad having a plurality of shared keys each corresponding to a plurality of different search query characters. In addition, the at least one predicted search query term may be a plurality thereof, and the processor may further preferentially rank advertising terms among the plurality of predicted search query terms. In accordance with one exemplary embodiment, the processor may visually highlight the predicted search query terms from the group of related advertising terms on the display.

Furthermore, the group of related advertising terms may have an expiration date associated therewith. As such, the processor may advantageously cease matching predicted search query terms from the group of related advertising terms after the expiration date. Further, the processor may cooperate with the display and user input device to display a plurality of search results based upon a selected one of the predicted search queries. Moreover, the advertising server may provide the at least one group of related advertising terms based upon selected search results.

The processor may further permit user designation of predicted search query terms as advertising terms. Additionally, the advertising server may also be for providing at least one advertising logo image, and the processor may also display the at least one advertising logo image if the at least one predicted search query term is among the at least one group of related advertising terms. By way of example, the mobile wireless communications device may comprise a cellular communications device.

A related mobile wireless communications device is also provided, such as the one described briefly above. In addition, a related communications method for a mobile wireless communications device including a display and a user input device is also provided. The method may include providing at least one group of related advertising terms, displaying a user search interface on the display of the mobile wireless communications device for permitting entering of search query characters using the user input device, and matching the entered search query characters to identify at least one predicted search query term. Moreover, if the at least one predicted search query term is among the at least one group of related advertising terms, then the method may further include displaying at least one other of the group that would otherwise not match the entered search query characters on the display.

A related computer-readable medium may have computer-executable instructions for causing a mobile wireless communications device including a display and a user input device to perform steps including displaying a user search interface on the display for permitting entering of search query characters using the user input device, and matching the entered search query characters to identify at least one predicted search query term. Moreover, if the at least one predicted search query term is among at least one group of related advertising terms, then a further step of displaying at least one other of the group that would otherwise not match the entered search query characters on the display may be performed.

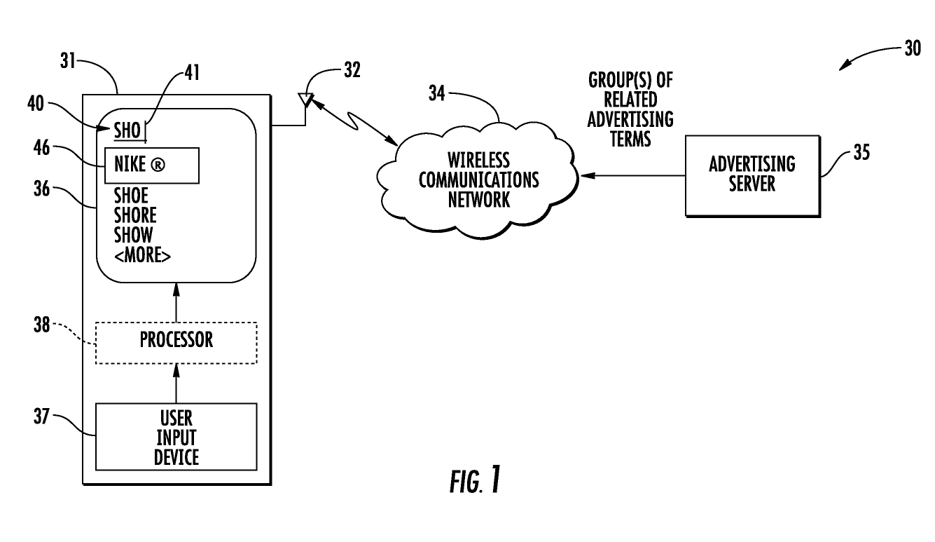

Turning now to FIGS. 1-3, a communications system 30 and associated communications method aspects are first described. The system 30 illustratively includes one or more mobile wireless communications devices 31 (MWCDs), or mobile devices for short, and associated antenna(s) 32, which may include internal antennas, external antennas, or both. Moreover, the system 30 further illustratively includes a wireless communications network 34, and an advertising server 35 that communicates with the mobile device 31 via the wireless communications network. In some embodiments, the advertising server 35 may communicate with the wireless communications network 34 via a wide area network, such as the Internet, for example (not shown).

By way of example, the mobile device 31 and wireless communications network 34 may operate in accordance with a cellular, wireless LAN (e.g., 802.11x, Bluetooth, etc.), WiMAX, satellite, etc., communications format, as will be appreciated by those skilled in the art. In some embodiments, more than one such wireless communications format may be used in the same device (e.g., cellular, wireless LAN, and Bluetooth). Various types of mobile wireless communications devices 31 may be used, such as mobile phones, PDAs, laptop computers, wireless-enabled cameras, wireless-enabled media players, etc., for example.

Beginning at Block 50, the advertising server 35 advantageously provides one or more groups of related advertising terms to the mobile wireless communications device(s) 31, at Block 51. More particularly, the group of related advertising terms may be part of an advertising term campaign sponsored by an advertiser seeking to drive search result traffic, such as Internet search traffic, to a particular Website, for example. In the example illustrated in FIG. 1, the group of advertising terms includes “shoe” and “Nike®”, although any number of related advertising terms could be included within the group.

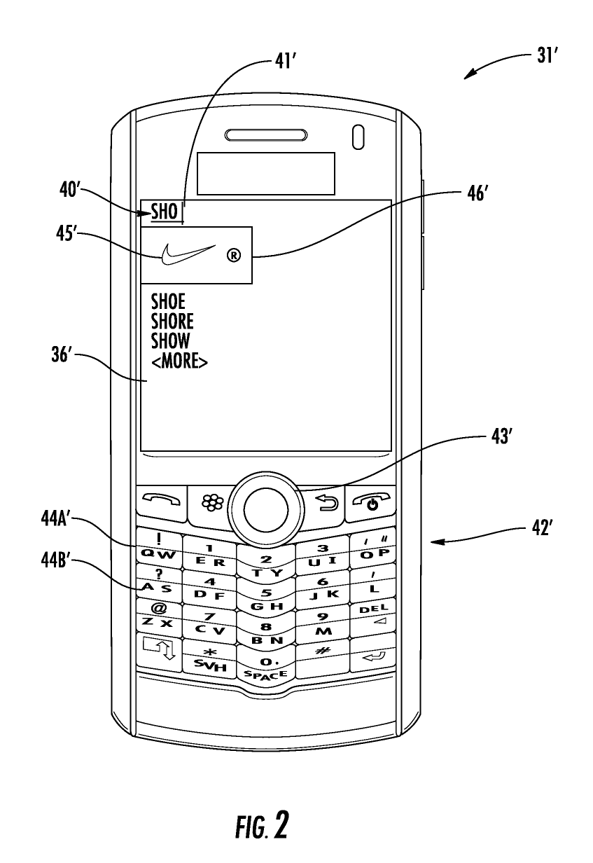

The mobile device 31 illustratively includes a display 36, a user input device 37, and a processor 38 coupled to the display and the user input device. By way of example, the display 36 may be a liquid crystal display (LCD) or other suitable display, as will be appreciated by those skilled in the art. As seen in the exemplary mobile device 31′ shown in FIG. 2, the user input device may take the form of a key pad 42′, a track ball 43′, etc. Also by way of example, the processor 38 may be implemented using a combination of hardware (e.g., microprocessor, memory, etc.) and software components, as will be appreciated by those skilled in the art.

The processor 38 causes a user search interface 40 to be displayed on the display 36 for permitting entering of search query characters, at Block 52. As seen in the example of FIG. 1, the user search interface 40 is in the upper left hand corner of the display 36 and it shows a character string input by the user. For example, in the embodiment of FIG. 2 as the user types in successive characters using the key pad 42′, these characters are successively displayed from left to right in the user search interface 40′ on the display 36′, although other user search interface arrangements may also be used. A cursor 41′ is displayed at the end of the entered character string to indicate to the user where a next character will be displayed when input, as will be appreciated by those skilled in the art.

The processor 38 matches the entered search query characters to identify one or more predicted search query terms, at Block 53. More particularly, a dictionary or similar list of available words or terms may be stored on the mobile device 31, or on the advertising server 35 (or other remotely located server) in some embodiments. In the example illustrated in FIG. 2, the key pad 42′ illustratively includes a plurality of shared keys 44′, each corresponding to a plurality of different search query characters. By way of example, in the illustrated embodiment a first shared key 44a′ has the letters “Q” and “W” and the exclamation point character (“!”) thereon, and a key 44b′ has the letter “A” and “S” and the question mark character (“?”) thereon.

Such a shared character key arrangement is particularly advantageous for reducing the space required for the key pad 42′, and may therefore advantageously allow smaller device sizes. However, it is often desirable to provide text disambiguation functionally with such an arrangement to assist users in typing desired terms, since typing can be somewhat more cumbersome if there is not an individual key for each character, as would be the case with a “full” key pad, e.g., a QWERTY key pad, as will be appreciated by those skilled in the art. In such an embodiment, the dictionary or list of terms used to predict such search query terms may be a predictive text dictionary. With each new key stroke, the processor 38 eliminates as possibilities those terms from the dictionary that would not match any possible combination of the key strokes, and would typically display only predicted search query terms that do match the key stroke sequence. It should be noted that a shared key pad arrangement need not be used in all embodiments, as full key pads may also be used, or some combination of a shared and full key pad, as will be appreciated by those skilled in the art.

In embodiments with predictive text entry, the group of related advertising terms may be added to an existing dictionary of terms, or it may be stored in a separate dictionary of advertising terms, for example. The predicted search query terms may be ranked based upon various criteria, including frequency of use (in general, by the user, or both), etc. Moreover, over time the processor 38 may track terms that are used more frequently and rank these terms higher in predicted search query term results. The dictionary (or dictionaries) of predicted search query terms may build with usage over time, that is, as users enter and select new terms not already in the dictionary then these terms may be added thereto by the processor 38.

In addition, such a dictionary of advertising terms may collect or include brands, product names, or other terms that are designated as relevant by the user. When these terms are added to the dictionary, there may be a “trigger” that lets the advertising server 35 know of the existence of the new term so that appropriate advertising term groups may be provided accordingly. Moreover, the terms in the dictionary may be filtered according to a relative value, i.e., the advertising server 35 may advantageously rank different terms with different values, for example, based upon a frequency of usage, etc. Also, advertisers may advantageously be allowed to pay additional fees to move their respective advertising terms up in rank order, as will be appreciated by those skilled in the art.

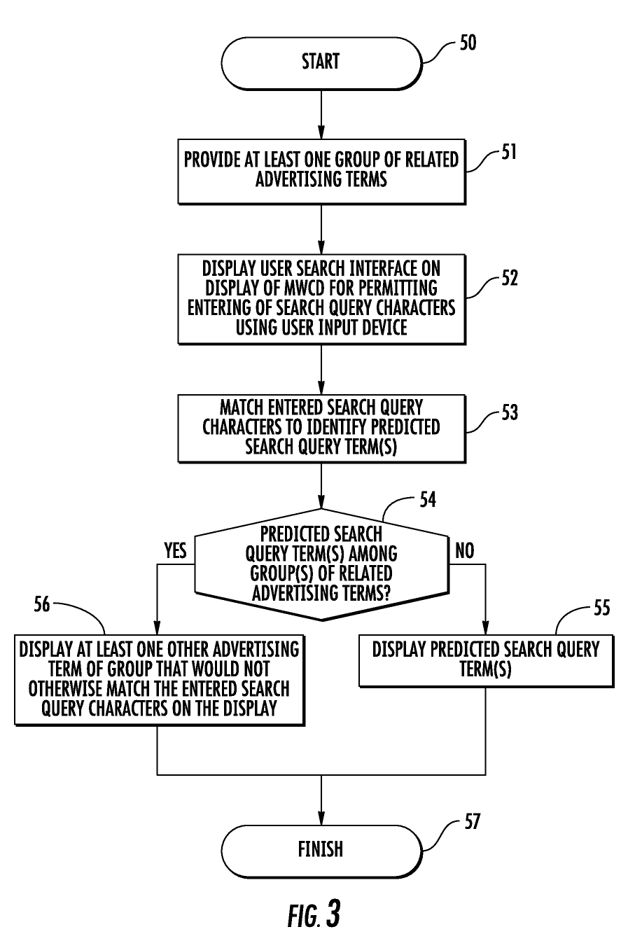

When a user enters a string or search query characters and one or more of the predicted search query terms is among the group of related advertising terms, then the processor 38 advantageously causes the display 36 to display at least one other term from the group that would otherwise not match the entered search query characters, at Blocks 54, 56, along with other matching predicted search query terms not in the group (if applicable). If none of the predicted search query terms is from the group of related advertising terms, then the processor 38 may display those terms that do match the search query character string, at Block 55, thus concluding the method illustrated in FIG. 3 (Block 57).

In the present example, the user has entered or spoken (in the case where the user input device 37 is a microphone, for example) the characters “s”, “h”, and “o”, which matches the returned search query terms “shoe”, shore”, and “show”. As noted above, “shoe” is in the designated group of advertising terms that also include “Nike®”, which does not match the entered character string and would not have otherwise been presented to the user on the display 36, but is presented on the display because it is in the related advertising term group. Accordingly, an advertiser may advantageously use common terms relating to its products or services to create an association to terms or slogans particularly associated with the goods or services, such as a corporate name, product/service name, etc. It should be noted that not all non-matching terms in a group of advertising terms need be displayed on the display 36 (i.e., it could be one or more). A “show all” option may be provided on the display 36 to permit the user to view all of the related terms within a given group thereof (or the full dictionary of advertising terms) in some embodiments, if desired.

In some embodiments, the advertising server 35 may also provide one or more advertising logo images to the device 31 as part of, or in association with, the group of related advertising terms. Thus, for example, the processor 38 may advantageously also display the advertising logo(s) along with (or in place of) an advertising term from among the group thereof. In the example illustrated in FIG. 2, the Nike® “swoosh” symbol 45 is displayed among the list of predicted search query terms in place of the term “Nike®” itself, which is displayed in the example of FIG. 1. The logo images may be in the form of bitmap, Joint Photographic Experts Group (JPEG), Graphics Interchange Format (GIF), or other suitable image/graphic files, as will be appreciated by those skilled in the art. Logo images may also be prioritized over plain advertising terms in some embodiments, if desired. Another option is that advertising terms could turn into associated logo images as a cursor is moved over them (with or without user selection), for example.

The processor 38 may also preferentially rank advertising terms among the plurality of predicted search query terms displayed on the display 36. In the examples of FIGS. 1 and 2, the term “Nike®” is placed at the top of the list of predicted search query terms. The advertiser may provide compensation to a provider of the wireless communications network 34, user, etc., for the ability to not only display the advertising terms but also to rank them ahead of other terms, as will be appreciated by those skilled in the art.

Similarly, the processor 38 may also advantageously visually highlight the predicted search query terms from the group of related advertising terms on the display. As seen in FIG. 1, for example, the term “Nike®” is within a shaded box or area, and in the example of FIG. 2 the “swoosh” symbol is highlighted within an outlined (and unshaded) box. Various visual highlighting techniques may be used, such as underlining, bold text, colored text, flashing text, enlarged text, pop-up indicators, etc., as will be appreciated by those skilled in the art. It should be noted that various combinations of ranking and highlighting including one, both, or neither, may be used in different embodiments. Moreover, forms of highlighting other than or in addition to visual highlighting may also be used, such as audio indictors, tactile indicators (e.g., a vibration), etc., as will also be appreciated by those skilled in the art.

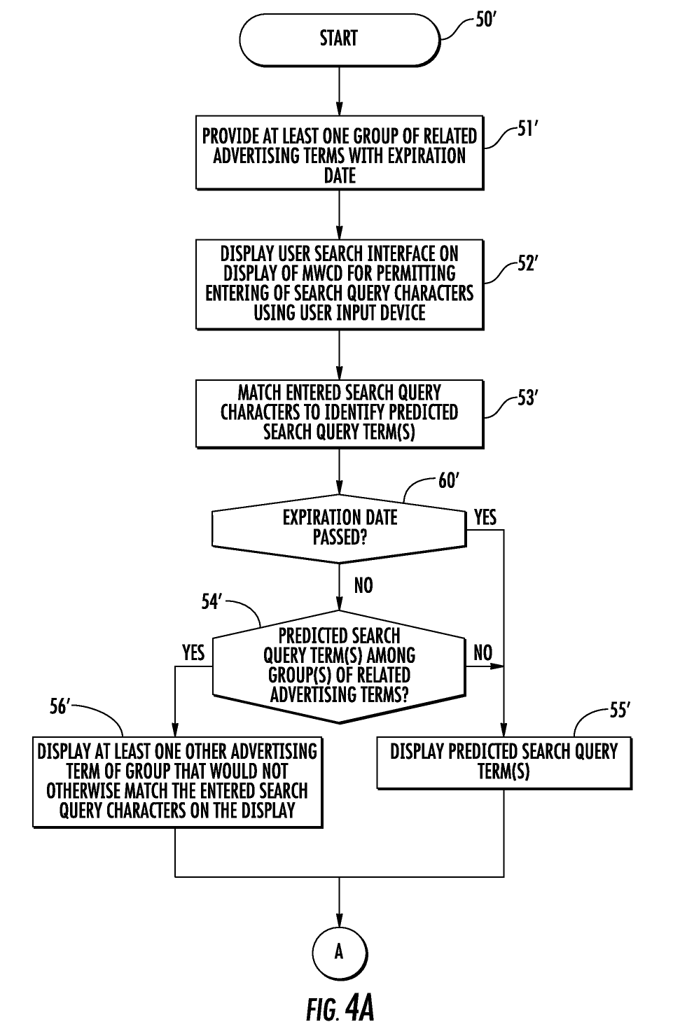

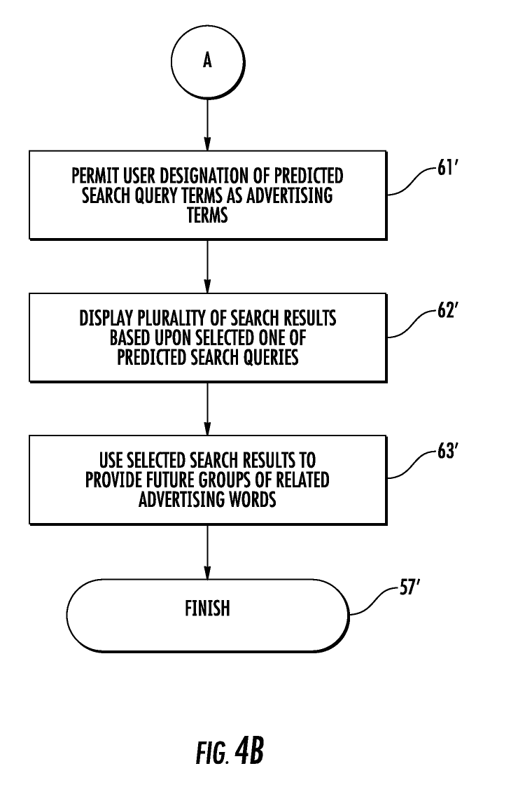

Referring additionally to FIGS. 4A-4B, the group of related advertising terms may have an expiration date associated therewith (Block 51′). For example, the expiration date may correspond to a length of time that an advertiser has paid to run a particular advertising program, and this information may be communicated from the advertising server 35 to the device 31 along with the group of related advertising terms. Accordingly, the processor 38 may further determine if the expiration date for the group of related advertising terms has expired or passed and, if so, cease matching predicted search query terms from the group of related advertising terms and thereby avoid including some or all of the advertising terms in the predicted search query terms output on the display 36, at Block 60′. For example, since the term “shoe” may be used in a non-advertisement context, the processor 38 may continue to display this term in response to the “s”, “h”, and “o” character string, but cease providing the “Nike®” term or the “swoosh” logo image after the expiration date. In some embodiments, upon expiration of a group of related advertising terms the user may be provided with an option to continue the use of the current terms, obtain related groups of terms (e.g., associated with new advertising campaigns), or optionally to allow the term usage to lapse. It should be noted that expiration may be relative (e.g., expire after a predetermined time period, such as 1 month, etc.) or absolute (e.g., expire on Dec. 31, 2009).

Furthermore, in some embodiments the processor 38 may advantageously allow the user to designate a predicted search query term (or terms) as an advertising term, at Block 61′, which allows it to be ranked above other terms, visually highlighted, etc. For example, the term “blackberry” may be provided as a predicted search query term responsive to the user's entered search query character string. If the user is looking for information on BlackBerry® mobile communications devices rather than the blackberry fruit, the user may be given the option to designate “BlackBerry®” as the particular term of interest (i.e., as an advertising term). The advertising server 35 may accordingly select groups of advertising terms that relate to (and potentially include) such designated search query terms since they are of interest to the user. An option may also be provided to remove a term from the designated advertising term list as well, so if the user looses interest in the particular item/subject the term (and potentially other related advertising terms) will not be preferentially ranked, visually highlighted, etc. Here again, a “show all” option may be provided so that the user is shown all of the terms in a group thereof (or all of the advertising terms) and may selectively remove the advertising terms (or groups thereof) that are not of interest.

Further, the processor 38 may cooperate with the display 36 and user input device(s) 37 to display a plurality of search results based upon a selected one of the predicted search queries, at Block 62′. Again referring to the example of an Internet search browser, upon selection of a predicted search query term (or series of terms), the browser application being run by the processor 38 initiates a search request to an Internet server (which may be the advertising server in some embodiments, but need not be in all embodiments) which returns one or more relevant search results. The browser application then causes these results to be displayed on the display 36, as will be appreciated by those skilled in the art. Moreover, the advertising server 35 may provide or select the group(s) of related advertising terms for the given device 31 based upon selected search results, at Block 63′. That is, the advertising server 35 may select groups of advertising terms that correspond to areas that are typically searched (e.g., shoes, apparel, etc.). Such search history information may be stored at the mobile device 31 or advertising server 35, for example.

It should be noted that the above-described advertising term search features may be used in other applications beside Internet searching or web searching. Generally speaking, the above-described approach may be used with numerous applications having a text input mode. For example, this approach may be used with other applications such as email, notes, to-do lists, calendar, contacts/address book, mapping applications, media players, games, shopping applications, document processing, chat or instant messenger programs, social networking applications, etc., as will be appreciated by those skilled in the art. Moreover, it may also be used generally in applications in which predictive text entry is utilized, as will also be appreciated by the skilled artisan.

Another advantageous feature of the above-described approach is that advertising terms may be selected, ranked, highlighted, or any combination thereof, based upon a given time of day or location of the mobile device 31. For example, certain advertising terms may be more appropriate to display at particular times of day (e.g., coffee-related terms in the morning), or when the user is at a particular location (e.g., shoe-related terms may be more appropriate when the user is in a mall).

The forgoing operations may also be embodied in a computer-readable medium having computer-executable instructions for causing a mobile wireless communications device 31 including a display 36 and a user input device 37 to perform steps including displaying a user search interface 40 on the display for permitting entering of search query characters using the user input device, and matching the entered search query characters to identify at least one predicted search query term. Moreover, if the at least one predicted search query term is among at least one group of related advertising terms, then a step of displaying at least one other term of the group or related advertising terms that would otherwise not match the entered search query characters on the display is performed.

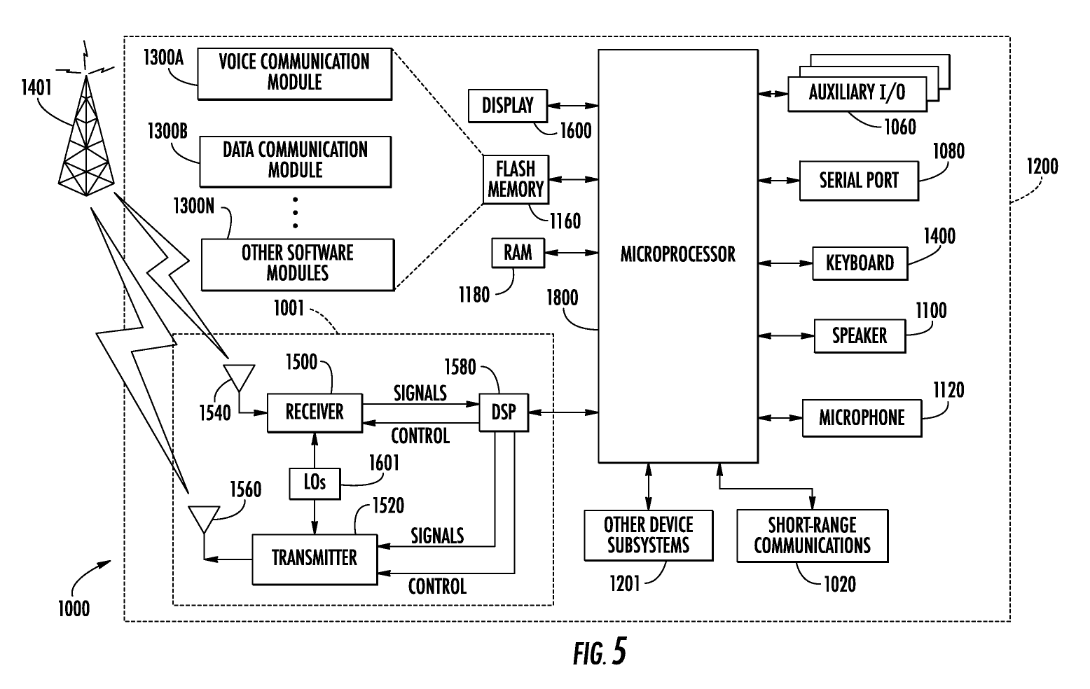

Exemplary components of a mobile wireless communications device 1000 that may be used in accordance with the system 30 are further described in the example below with reference to FIG. 5. The device 1000 illustratively includes a housing 1200, a key pad 1400 and an output device 1600. The output device shown is a display 1600, which may comprise a full graphic LCD. In some embodiments, display 1600 may comprise a touch-sensitive input and output device. Other types of output devices may alternatively be utilized. A processing device 1800 is contained within the housing 1200 and is coupled between the key pad 1400 and the display 1600. The processing device 1800 controls the operation of the display 1600, as well as the overall operation of the mobile device 1000, in response to actuation of keys on the key pad 1400 by the user. In some embodiments, key pad 1400 may comprise a physical key pad or a virtual key pad (e.g., using a touch-sensitive interface) or both.

The housing 1200 may be elongated vertically, or may take on other sizes and shapes (including clamshell housing structures). The key pad 1400 may include a mode selection key, or other hardware or software for switching between text entry and telephony entry.

In addition to the processing device 1800, other parts of the mobile device 1000 are shown schematically in FIG. 5. These include a communications subsystem 1001; a short-range communications subsystem 1020; the key pad 1400 and the display 1600, along with other input/output devices 1060, 1080, 1100 and 1120; as well as memory devices 1160, 1180 and various other device subsystems 1201. The mobile device 1000 may comprise a two-way RF communications device having voice and data communications capabilities. In addition, the mobile device 1000 may have the capability to communicate with other computer systems via the Internet.

Operating system software executed by the processing device 1800 may be stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TAC™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as 3GSM, 3G, UMTS, 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore utilizes a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as e-mail messages, using the key pad 1400 and/or some other auxiliary I/O device 1060, such as a touchpad, a rocker switch, a thumb-wheel, track ball, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, or a Bluetooth™ communications module to provide for communication with similarly-enabled systems and devices.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims. That which is claimed is:

1. A communications system comprising:
an advertising server for providing at least one group of related advertising terms; and
a mobile wireless communications device comprising
a display,
a user input device, and
a processor coupled to said display and said user input device and configured to
displaying a user search interface on said display,
receive entry of search query character data from the user input device,
match the entered search query character data to identify at least one predicted search query term, and
if the at least one predicted search query term is among the at least one group of related advertising terms, then display at least one other of the group that would otherwise not match the entered search query character data.

2. The communications system of claim 1 wherein said user input device comprises a key pad having a plurality of shared keys each corresponding to a plurality of different search query characters.

3. The communications system of claim 1,
wherein the at least one predicted search query term comprises a plurality thereof; and
wherein said processor further preferentially ranks advertising terms among the plurality of predicted search query terms.

4. The communications system of claim 1 wherein said processor is configured to visually highlights the predicted search query terms from the group of related advertising terms on said display.

5. The communications system of claim 1,
wherein said group of related advertising terms has an expiration date associated therewith; and
wherein said processor ceases matching predicted search query terms from the group of related advertising terms after the expiration date.

6. The communications system of claim 1 wherein said processor further cooperates with said display and user input device to render on the display a plurality of search results based upon a selected one of the predicted search queries.

7. The communications system of claim 6 wherein said advertising server is configured to provide the at least one group of related advertising terms based upon selected search results.

8. The communications system of claim 1 wherein said processor further permits user designation of predicted search query terms as advertising terms.

9. The communications system of claim 1,
wherein said advertising server is also for configured to provide at least one advertising logo image; and
wherein said processor also displays the at least one advertising logo image if the at least one predicted search query term is among the at least one group of related advertising terms.

10. The communications system of claim 1 wherein said mobile wireless communications device comprises a cellular communications device.

11. A mobile wireless communications device comprising:
a display;
a user input device; and
a processor coupled to said display and said user input device and configured to
display a user search interface on said display,
receive entry of search query character data from the user input device,
match the entered search query character data to identify at least one predicted search query term, and
if the at least one predicted search query term is among at least one group of related advertising terms, then display at least one other of the group that would otherwise not match the entered search query character data.

12. The mobile wireless communications device of claim 11 wherein said user input device comprises a key pad having a plurality of shared keys each corresponding to a plurality of different search query characters.

13. The mobile wireless communications device of claim 11,
wherein the at least one predicted search query term comprises a plurality thereof; and
wherein said processor further preferentially ranks advertising terms among the plurality of predicted search query terms.

14. The mobile wireless communications device of claim 11 wherein said processor is configured to visually highlight the predicted search query terms from the group of related advertising terms on said display.

15. The mobile wireless communications device of claim 11,
wherein said group of related advertising terms has an expiration date associated therewith; and
wherein said processor ceases matching predicted search query terms from the group of related advertising terms after the expiration date.

16. The mobile wireless communications device of claim 11 wherein said processor further permits user designation of predicted search query terms as advertising terms.

17. A communications method for a mobile wireless communications device comprising a display and a user input device, the method comprising:
providing at least one group of related advertising terms;
displaying a user search interface on the display of the mobile wireless communications device for permitting entering of search query character data using the user input device;
matching the entered search query character data to identify at least one predicted search query term; and
if the at least one predicted search query term is among the at least one group of related advertising terms, then displaying at least one other of the group that would otherwise not match the entered search query character data on the display.

18. The method of claim 17 wherein the user input device comprises a key pad having a plurality of shared keys each corresponding to a plurality of different search query characters.

19. The method of claim 17 wherein the at least one predicted search query term comprises a plurality thereof; and further comprising preferentially ranking advertising terms among the plurality of predicted search query terms.

20. The method of claim 17 further comprising visually highlighting the predicted search query terms from the group of related advertising terms on the display.

21. The method of claim 17 wherein the group of related advertising terms has an expiration date associated therewith; and further comprising ceasing matching predicted search query terms from the group of related advertising terms after the expiration date.

22. A computer-readable medium having computer-executable instructions for causing a mobile wireless communications device comprising a display and a user input device to perform steps comprising:
displaying a user search interface on the display for permitting entering of search query characters using the user input device;
matching the entered search query characters to identify at least one predicted search query term; and
if the at least one predicted search query term is among at least one group of related advertising terms, then displaying at least one other of the group that would otherwise not match the entered search query characters on the display.

23. The computer-readable medium of claim 22 wherein the at least one predicted search query term comprises a plurality thereof; and wherein the computer-readable medium further has computer-executable instructions for causing the mobile wireless communications device to preferentially rank advertising terms among the plurality of predicted search query terms.

24. The computer-readable medium of claim 22 further having computer-executable instructions for causing the mobile wireless communications device to visually highlight the predicted search query terms from the group of related advertising terms on the display.

25. The computer-readable medium of claim 22 wherein the group of related advertising terms has an expiration date associated therewith; and further having computer-executable instructions for causing the mobile wireless communications device to cease matching predicted search query terms from the group of related advertising terms after the expiration date.
